(19) United States
(12) Patent Application Publication
(10) Pub. No.: US 2016/0007280 A1
(43) Pub. Date: Jan. 7, 2016

(54) DISCONTINUOUS TRANSMISSION METHOD FOR BASE STATION OF A SMALL CELL IN A HETEROGENEOUS NETWORK

(71) Applicant: Commissariat a L'Energie Atomique et aux Energies Alternatives, Paris (FR)

(72) Inventors: Dimitri KTENAS, Voreppe (FR); Antonio DE DOMENICO, Grenoble (FR)

(73) Assignee: Commissariat a L'Energie Atomique et aux Energies Alternatives, Paris (FR)

(21) Appl. No.: 14/789,007

(22) Filed: Jul. 1, 2015

(30) Foreign Application Priority Data
Jul. 2, 2014 (FR) 14 56304

(51) Int. Cl. H04W 52/02; H04W 72/04

(52) U.S. Cl. CPC H04W 52/0206; H04W 72/0413; H04W 88/08

(57) ABSTRACT

A discontinuous transmission method for a base station of a small cell in a heterogeneous network. Depending on the filling state of the buffer or the lifetime of the data, the base station decides to send the data in an element frame or, on the contrary, to enter standby during that frame. In the event it decides to send the data, it ensures beforehand that no base station of an adjacent small cell is in the process of transmitting. Otherwise, it goes into standby for a pseudorandom duration before trying a new transmission of said data.

### TECHNICAL FIELD

The present invention generally relates to the field of cellular telecommunications, and more specifically that of heterogeneous networks in which macro-cells and small cells (according to the 3GPP/LTE-Advanced terminology) coexist, in particular picocells and femtocells.

### BACKGROUND OF THE INVENTION

The traditional second- or third-generation cellular systems generally call on the deployment of cells of a single and same type. However, 4^{th} generation systems like those obeying the “LTE-advanced” standard can use superimposed layers of cells of different sizes. Thus, small cells served by base stations with a relatively low transmission power (of approximately several watts) may coexist with conventional macro-cells (several tens of Watts). Furthermore, the small cells are characterized by a power consumption of approximately ten Watts, while macro-cells may consume up to 1300 Watts. Macro-cells in particular serve to ensure the coverage and management of user mobility, while the small cells can be activated dynamically to handle a traffic peak or cover hotspots. In the rest of this document, we will use the term “small cells” to refer to cells smaller than the traditional macro-cells and coexisting with the latter in a heterogeneous network (also called “Het Net”). Thus, the term “small cell” is understood below generically and hereinafter covers both the notions of femtocells and microcells, or even picocells. The small cells use a different carrier frequency from that used by the macro-cell. Thus, there is no interference from the macro-cell on small cell users.

To clarify things, the small cells have a coverage from approximately ten meters to approximately one hundred meters. They are generally deployed in urban or residential settings and installed in public places with high traffic or hotspots. They can also be used to improve the throughput and coverage in businesses or in individual homes.

The small cell density may reach up to approximately one thousand per macro-cell. Because this multiplication of small cells leads to significant energy consumption in the network, a smart and dynamic activation mechanism for these cells is used to limit the average energy consumption while guaranteeing the required quality of service (QoS).

One of the activation mechanisms currently considered consists of turning off (or putting on standby) the base station serving a small cell when the latter has no data to transmit. More specifically, the station deactivates certain components of its RF stage in the absence of data to be transmitted on the downlink path. Such a discontinuous transmission mode (DTX) has been described in the article by P. Frenger et al. entitled “Reducing energy consumption in LTE with cell DTX” published in IEEE Proc. of 73rd Vehicular Technology Conference, pp. 1-5, 15-18 May 2011.

This discontinuous transmission mode is, however, incompatible with the need to transmit certain pilot signals, even in the absence of any active user in the small cell. Thus, for example, release 10 of the “LTE advanced” 3GPP standard itself provides for transmitting, in each sub-frame of a radio frame (an LTE radio frame is made of 10 sub-frames each having a duration of 1 ms), pilot signals called Cell-Specific Reference Signals (CSRS) making it possible, inter alia, to manage user mobility (cell search mechanism), estimate the downlink channel between each antenna of the base station and the user terminal, and evaluate the quality of the channel on the downlink.

FIG. 1 diagrammatically shows a radio frame for the downlink path of an LTE network.

It will be recalled that, in an LTE system, the transmission on the downlink is done by OFDMA (Orthogonal Frequency Division Multiple Access). The CSRS signals are in fact OFDMA pilot symbols repeating upon each sub-frame T, as indicated in the figure.

Due to the structure of the LTE frame, it is understood that the interruption of the transmission can only occur between the transmission moments of the CSRS pilot symbols, i.e., for a maximum duration θ between those moments. This particular interruption mode for the transmission between pilot symbols is known in the literature under the name micro-DTX (micro-discontinuous transmission). It is, however, possible to find a description of the micro-DTX transmission mode in the aforementioned article by P. Frenger.

However, the energy gains of a micro-discontinuous transmission are relatively limited, since it can be shown that the RF stage of the base station can only be deactivated a maximum of 53% of the time during which there is no data to be transmitted.

Greater energy gains can be obtained by adopting a new LTE frame structure, called NCT (New Carrier Type), making it possible to adapt the signaling to the load of the cell. This new frame is characterized by the fact that the pilot signals are only transmitted in a sub-frame when there is data to be sent. The adoption of this new frame structure makes it possible to interrupt the transmission up to 4 consecutive sub-frames, given that synchronization signals must be transmitted every 5 sub-frames so as to synchronize the different users.

Another solution consists of offloading most of the control signals toward the macro-cell. The latter then handles the management of the mobility and connection establishment functionalities, while the small cells essentially handle conveying data. Offloading the control signals affords the possibility of placing the small cells on standby more easily, and therefore of further reducing energy consumption. This strategy is known in the state of the art as macro-assistance. A description of this strategy is provided in the white paper by Ericsson entitled “LTE release 12”, January 2013. This assumes, however a double connectivity capability, inasmuch as the user terminal must be able to establish a connection both with the base station of the microcell and the base station of the small cell on which it depends.

Irrespective of the adopted discontinuous transmission solution, with or without macro-systems, the small cells become activated and turned off in a disorderly manner in a heterogeneous cellular network. This disorderly activation harms the reliability of the channel estimate, that estimate only being able to be done when the small cell on which the user depends is active. Furthermore, when several adjacent cells are activated at the same time, the users of those cells can experience interference peaks that increase the packet error rate and therefore significantly reduce the transmission performance.

The aim of the present invention is consequently to propose a discontinuous transmission method for a base station for a small cell in a heterogeneous network, that does not have the drawbacks of the state of the art, in other words, that makes it possible to obtain a significant reduction in the energy consumption of the network without a significant reduction in the transmission performance.

### BRIEF DESCRIPTION OF THE INVENTION

The present invention is defined by a discontinuous transmission method for a base station of a small cell in a heterogeneous network, said base station being adapted to transmit data on the downlink path using elementary frames, said method comprising the following steps:
the base station determines, from the state of its transmission buffer, whether data needs to be sent, and
if not, the base station deactivates all or part of its RF stage for the duration of the elementary frames;
if yes, the base station determines whether a base station of an adjacent small cell is in the process of transmitting, and
   if that is not the case, sends the data in the elementary frame;
   if it is the case, waits for a pseudorandom duration before trying a new transmission of said data.

Advantageously, the station determines whether data is to be sent by comparing the quantity of data stored in the buffer with a minimum quantity of data.

The minimum quantity of data can be obtained as a function of the capacity of the downlink path and the duration of the elementary frame.

According to one alternative, the base station determines whether data is to be sent by comparing the remaining lifetime of the data stored in the buffer with a predetermined threshold value.

According to a first alternative, the base station determines whether a base station of an adjacent small cell is in the process of transmitting by listening to the pilot signals of the latter.

According to a second alternative, the base station determines whether a base station of an adjacent small cell is in the process of transmitting from the signal-to-interference-plus-noise ratio of its uplink path.

According to a third alternative, the base station determines whether a base station of an adjacent small cell is in the process of transmitting from transmission statistics of the latter.

According to a fourth alternative, the base station determines whether a base station of an adjacent small cell is in the process of transmitting from information sent by the latter, via a wired transmission channel or a radio transmission channel.

Irrespective of the alternative, when the base station determines that no base station of an adjacent cell is in the process of transmitting, it can transmit pilot symbols in addition to all or part of the data stored in the buffer.

Furthermore, when the base station determines that a base station of an adjacent small cell is in the process of transmitting, the pseudorandom duration for the new transmission can be obtained as the product of a base duration with a pseudorandom number taking its values from a given interval.

This base duration can be obtained from a filling state of the buffer and/or the remaining lifetime of the data stored therein.

Furthermore, when the base station determines that data is to be sent, it advantageously computes a cost function depending on the average energy consumption of the base station and a quality of service indicator, said cost function being an increasing function of the average energy consumption and the quality of service indicator, and if the value of the cost function is above a predetermined maximum value, the base station deactivates all or part of its RF stage for the duration of the elementary frame.

The cost function is for example a linear combination of the energy consumption of the base station and a quality of service indicator.

In one typical example embodiment, the heterogeneous network is an advanced LTE network.

### BRIEF DESCRIPTION OF THE DRAWINGS

Other features and advantages of the invention will become apparent upon reading one preferred embodiment of the invention, with reference to the attached figures, in which:

FIG. 1 diagrammatically illustrates the structure of an LTE radio frame on the downlink path;

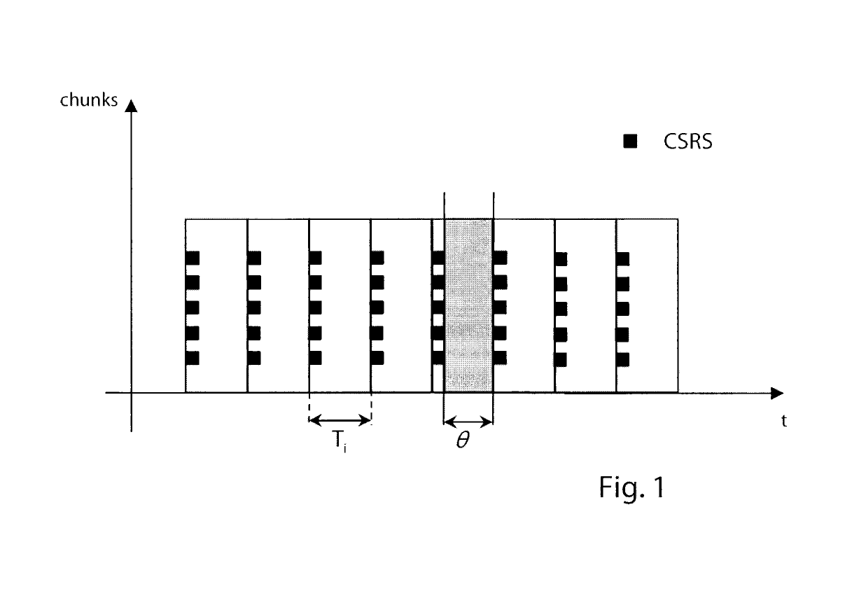

FIG. 2 diagrammatically shows a discontinuous transmission method for base station of a small cell in a heterogeneous network, according to a first embodiment of the invention;

FIG. 3 diagrammatically shows a discontinuous transmission method for a base station of a small cell in a heterogeneous network, according to a second embodiment of the invention.

### DETAILED DESCRIPTION OF THE INVENTION

Hereinafter, a heterogeneous cellular telecommunications network will be considered, made up of a first layer of macro-cells and a second layer of small cells within the meaning defined above, for example a network of the advanced LTE type. One skilled in the art will understand that other types of heterogeneous networks could also be considered, combining different access networks, without going beyond the scope of the present invention. For example, the invention is applicable to a multi-RAT network (RAT: Radio Access Technology) making it possible to access the GSM/UMTS/LTE and Wi-Fi networks. A description of a multi-RAT network may be found in the article by P. Xing et al., entitled “Multi-RAT network architecture”, Wireless World Research Forum, version 2.0, November 2013.

Irrespective of the considered heterogeneous network, it will be assumed that each small cell of the network is served by a base station that can be activated or placed on standby dynamically. Activation/placement on standby of a base station refers to the activation/placement on standby of all or part of the RF stage of its transmitter, in particular the power amplifiers that it includes. In addition to the RF stage (or only part thereof), certain circuits of the modulation stage (OFDMA modulation stage in the case of an advanced LTE network) can also be activated/placed in standby.

It will further be assumed that the data is sent in the form of elementary frames (for example, sub-frames in an LTE system).

The principle of the invention is not to activate the base station when the latter has no data to be sent over the downlink path and, otherwise, to verify that the base stations of the adjacent small cells are not in the process of transmitting, before sending the data, and if applicable pilot symbols, in an elementary frame.

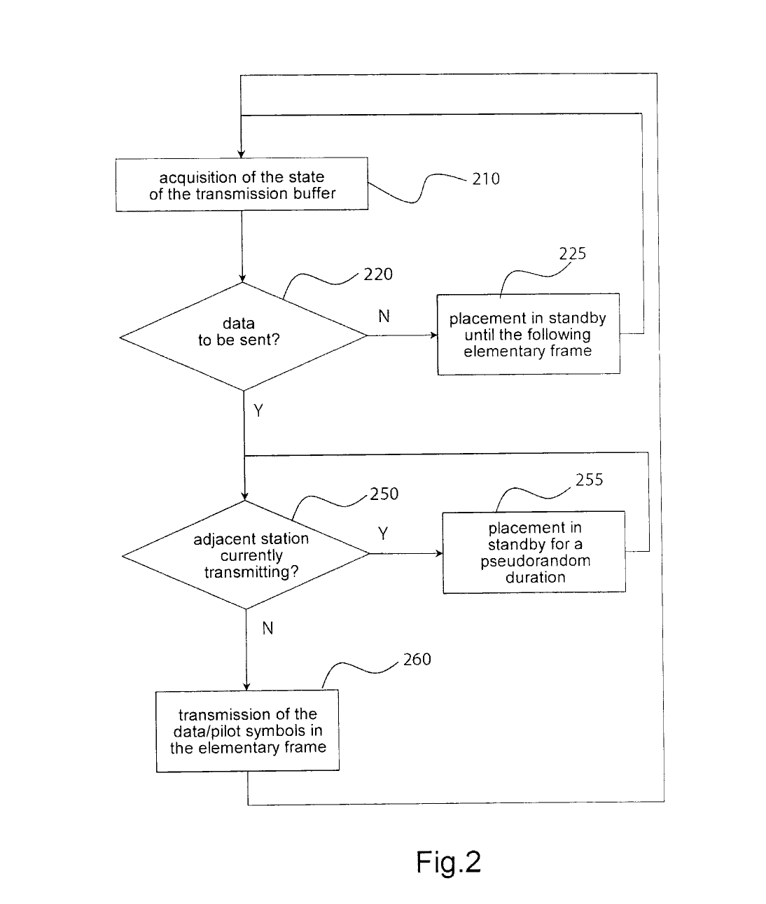

More specifically, FIG. 2 shows a discontinuous transmission method for a base station of a small cell, according to a first embodiment of the invention.

In step 210, the base station acquires the state of its transmission buffer.

In step 220, the base station verifies the state of that buffer. The verification of the buffer may simply consist of verifying the presence of a minimum quantity of data to be sent. When the quantity of data is sufficient, the base station goes on to step 250. The quantity is deemed sufficient if it is greater than the minimum quantity of data, depending on the capacity of the downlink connection and the duration of the elementary frame. If the quantity of data is insufficient, the base station goes into standby mode in 225 until the beginning of the following elementary frame, by deactivating all or part of its RF stage. However, even if the quantity of data is insufficient but the remaining lifetime of certain data in the buffer is below a predetermined threshold (latency constraint for real-time data, for example), the base station again goes on to step 250. In one alternative embodiment, it is possible to provide a buffer that is split into two parts, i.e., a first part containing the data subject to a latency constraint (for example, real-time flow) and a second part containing the other data. When the remaining lifetime of the data in the first part of the buffer is below said threshold but the quantity of that data is below the aforementioned minimum quantity, it is completed by data stored in the second part, up to said minimum quantity, before going on to step 250.

In step 250, the base station determines whether a base station of an adjacent small cell is in the process of transmitting.

According to a first alternative, the base station can listen to pilot signals transmitted by the adjacent base stations. If it detects the presence of such pilot signals, it deduces that at least one base station of an adjacent cell is in the process of transmitting.

According to a second alternative, it measures the signal-to-interference-plus-noise ratio (SINR) on the uplink path. If this ratio is above a predetermined level, it concludes that a transmission is underway in an adjacent small cell.

According to a third alternative, the base station uses the transmission statistics of the base stations at the adjacent small cells to predict whether a transmission will take place in one of them during the elementary frame. These statistics can have been established using prior measuring campaigns or result from learning over the course of successive transmission attempts.

Lastly, according to a fourth alternative, if an exchange of information between base stations of adjacent small cells is possible, whether by wired path or a dedicated radio channel, each base station can be informed directly that the adjacent base station is in the process of transmitting. This exchange of information can be done from base station to base station or coordinated locally by a control station responsible for a cluster of adjacent small cells. The control station may be a specific base station. It should be noted that, in that case, other information can be exchanged between adjacent base cells, in particular the states of the respective buffers or the latency constraints of their respective data. Thus, owing to this information, when several adjacent base stations are preparing to transmit simultaneously, arbitration can be done, either in a distributed manner or in a centralized manner, to determine which will be given priority for its transmission.

Whatever the considered alternative, if the base station determines that a station of an adjacent small cell is in the process of transmitting, it goes into standby for a pseudorandom duration in 255.

The pseudorandom duration may be proportional to a base duration that depends on the latency constraints of the data stored in the buffer (or in its first part, in the alternative mentioned above) and/or the filling state of the buffer. Thus, this base duration will be shorter when the remaining lifetime of the data is low and/or the buffer is full. The pseudorandom duration may be computed as the product of the base duration by a pseudorandom number obtained by randomly selecting within a given interval.

At the end of that pseudorandom duration, the base station returns to step 250 for a new transmission attempt.

However, if the base station determines in step 250 that no base station of an adjacent small cell is sending data, it goes onto the transmission step 260.

In step 260, the base station sends, during the current elementary frame, the data stored in its buffer, on the downlink path. During that same elementary frame, it can also send pilot symbols allowing the users of the small cell to perform a channel estimate. This channel estimate can next be sent to the base station in the form of a channel state indicator (CSI). The base station can choose whether to send pilot symbols with the data depending on whether it needs to update its knowledge of the channel state. This choice can in particular depend on the required quality of service (QoS), the state of the buffer as previously defined, and the quality of the radio channel (attenuation, presence or absence of interference). It will in fact be understood that if the quality of service is high and/or if the data to be transmitted belongs to real-time traffic, pilot symbols must be transmitted with the data in the elementary frame.

At the end of the transmission of the elementary frame, one returns to step 210 for a new acquisition of the buffer state.

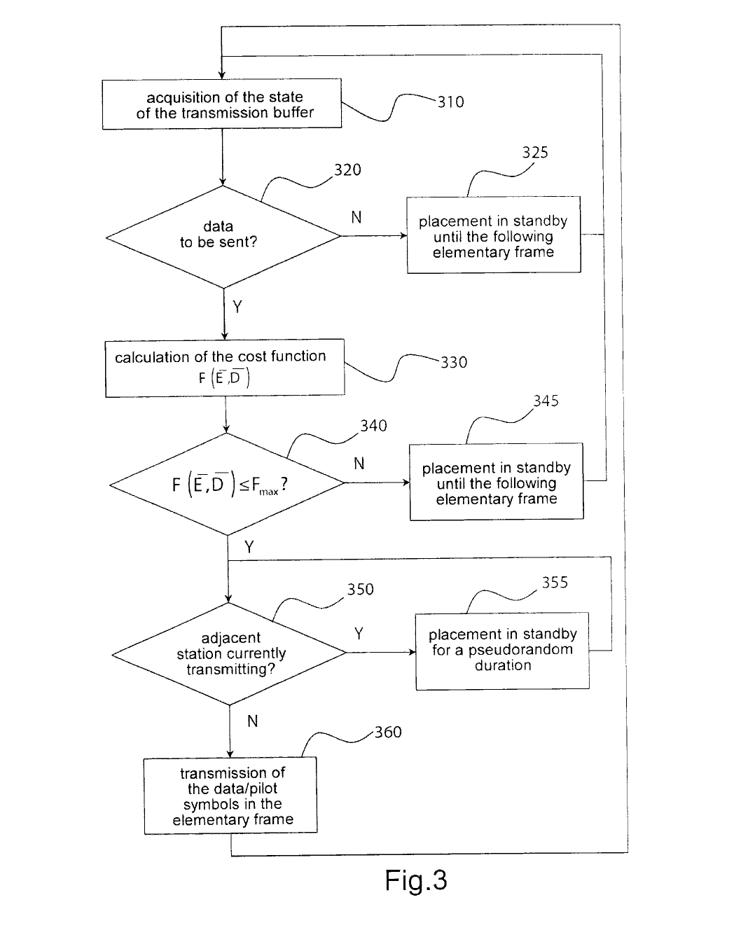

FIG. 3 shows a discontinuous transmission method for a base station of a small cell, according to a second embodiment of the invention.

Steps 310 to 360 are identical to steps 210 to 260, and will therefore not be described again here.

The second embodiment differs from the first embodiment in that the transmission of data on the downlink path is subject to meeting an additional condition in step 330. In fact, in that step, a cost function is computed depending on the average energy consumption of the base station and a quality of service (QoS) indicator. Depending on the considered case, the quality of service indicator may be defined as the inverse of the average latency of the packets sent on the downlink path or the packet error rate, or as the average binary throughput. In general, the cost function is an increasing function of the average energy consumption of the base station and the quality of service indicator observed on the downlink path.

For example, the cost function may be expressed in the form of a linear combination:

F(Ē, D̅)=γĒ+(1−γ) D̅

where Ē is the average energy consumed by the base station, D̅ is the aforementioned quality of service indicator and γ is a parameter comprised between 0 and 1 weighting the relative importance given to the energy consumption and the quality of service. Other expressions of the cost function may be considered by one skilled in the art without going beyond the scope of the present invention, for example a multiplicative combination of the type:

F(Ē, D̅)=Ē^{γ} D̅^{1-γ}

The cost function cannot be completely recalculated upon each elementary frame, but simply updated using a recursive low pass filter with a forgetting factor. Alternatively, the cost function may be computed beforehand and its values stored in a look-up table indexed by the average energy and the service indicator.

In step 340, it is verified whether the cost is below a predetermined maximum cost. If so, one goes on to step 350 for a transmission attempt. Otherwise, the base station is placed on standby in 355 until the beginning of the following elementary frame.

1. A discontinuous transmission method for a base station of a small cell in a heterogeneous network, said base station being adapted to transmit data on the downlink path using elementary frames, wherein:
the base station determines, from the state of its transmission buffer, whether data needs to be sent, and
if not, the base station deactivates all or part of its RF stage for the duration of the elementary frames;
if yes, the base station determines whether a base station of an adjacent small cell is in the process of transmitting, and
if that is not the case, sends the data in the elementary frame;
if it is the case, waits for a pseudorandom duration before trying a new transmission of said data.

2. The discontinuous transmission method according to claim 1, wherein the base station determines whether data is to be sent by comparing the quantity of data stored in the buffer with a minimum quantity of data.

3. The discontinuous transmission method according to claim 2, wherein the minimum quantity of data can be obtained as a function of the capacity of the downlink path and the duration of the elementary frame.

4. The discontinuous transmission method according to claim 1, wherein the base station determines whether data is to be sent by comparing the remaining lifetime of the data stored in the buffer with a predetermined threshold value.

5. The discontinuous transmission method according to claim 1, wherein the base station determines whether a base station of a small adjacent cell is in the process of transmitting by listening to the pilot signals of the latter.

6. The discontinuous transmission method according to claim 1, wherein the base station determines whether a base station of an adjacent small cell is in the process of transmitting from the signal-to-interference-plus-noise ratio of its uplink path.

7. The discontinuous transmission method according to claim 1, wherein the base station determines whether a base station of a small adjacent cell is in the process of transmitting from transmission statistics of the latter.

8. The discontinuous transmission method according to claim 1, wherein the base station determines whether a base station of an adjacent small cell is in the process of transmitting from information sent by the latter, via a wired transmission channel or a radio transmission channel.

9. The discontinuous transmission method according to claim 1, wherein the base station determines that no base station of an adjacent cell is in the process of transmitting, it transmits pilot symbols in addition to all or part of the data stored in the buffer.

10. The discontinuous transmission method according to claim 1, wherein the base station determines that a base station of an adjacent small cell is in the process of transmitting, the pseudorandom duration for the new transmission is obtained as the product of a base duration with a pseudorandom number taking its values from a given interval.

11. The discontinuous transmission method according to claim 10, wherein the base duration is obtained from a filling state of the buffer and/or the remaining lifetime of the data stored therein.

12. The discontinuous transmission method according to claim 1, wherein the base station determines whether data is to be sent, it computes a cost function depending on the average energy consumption of the base station and a quality of service indicator, said cost function being an increasing function of the average energy consumption and the quality of service indicator, and if the value of the cost function is above a predetermined maximum value, the base station deactivates all or part of its RF stage for the duration of the elementary frame.

13. The discontinuous transmission method according to claim 12, wherein the cost function is a linear combination of the energy consumption of the base station and a quality of service indicator.

14. The discontinuous transmission method according to claim 1, wherein the heterogeneous network is an LTE advanced network.
